(19) United States
(12) Patent Application Publication
(10) Pub. No.: US 2024/0354098 A1
(43) Pub. Date: Oct. 24, 2024

(54) INFORMATION PROCESSING DEVICE, INFORMATION PROCESSING METHOD, AND NON-TRANSITORY STORAGE MEDIUM STORING MANAGEMENT PROGRAM

(71) Applicants: TOYOTA JIDOSHA KABUSHIKI KAISHA, Toyota-shi (JP); Woven by Toyota, Inc., Tokyo (JP)

(72) Inventors: Takahiro UTSUNOMIYA, Tokyo (JP); Junichiro TAMAO, Tokyo (JP); Tomoaki KARASAWA, Matsudo-shi (JP); Takumi HORIE, Chofu-shi (JP); Kirk SHOOP, Seattle, WA (US)

(73) Assignees: TOYOTA JIDOSHA KABUSHIKI KAISHA, Toyota-shi, Aichi-ken (JP); Woven by Toyota, Inc., Tokyo (JP)

(21) Appl. No.: 18/636,459

(22) Filed: Apr. 16, 2024

(30) Foreign Application Priority Data
Apr. 19, 2023 (JP) 2023-068507

(51) Int. Cl. G06F 8/654

(52) U.S. Cl. CPC G06F 8/654

(57) ABSTRACT

An information processing device configured to update stored content of a storage device of a vehicle includes an execution device, a first storage unit, and a second storage unit. The execution device is configured to store data received from a different controlling device in a first storage area of the second storage unit, and request, when a prescribed update condition is met, writing of the data stored in the first storage area to the storage device, and thereafter notify the different controlling device that writing of the data has been completed. The execution device is configured to store, when writing of data to the storage device is requested, the data stored in the first storage area in the second storage area of the second storage unit, and thereafter write the data stored in the second storage area to the storage device.

### BACKGROUND

### 1. Field

The present disclosure relates to an information processing device that manages a storage device, an information processing method, and a non-transitory storage medium that stores a management program.

### 2. Description of Related Art

Japanese Laid-Open Patent Publication No. 2021-135511 discloses a system for managing multiple storage devices.

In general, an execution device of an information processing device that manages a storage device updates storage contents of the storage device by executing an operating system. In this case, the execution device stores data transmitted by a different controlling device in a cache memory. Then, the execution device writes the data from the cache memory to the storage device. At this time, the execution device writes the data from the cache memory to the storage device at a timing determined by the execution device itself. Therefore, the different controlling device cannot ascertain at what timing the data it transmitted was written to the storage device.

If the different controlling device transmits, to the information processing device, an instruction to write the data to the storage device after transmitting the data, the different controlling device can ascertain that the data has been written to the storage device. However, in this case, since the different controlling device transmits the instruction to the information processing device, the number of times that the different controlling device accesses the information processing device increases.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an information processing device is configured to update stored content of a storage device of a vehicle based on data received from a different controlling device. The information processing device includes a processor, a first storage unit, and a second storage unit. The first storage unit is configured to store an operating system and a management program executed on the operating system. The second storage unit includes a first storage area and a second storage area. The processor is configured to execute the management program so as to store the data received from the different controlling device in the first storage area, and request, when a prescribed update condition is met, writing of the data stored in the first storage area to the storage device, and thereafter notify the different controlling device that writing of the data has been completed. The processor is configured to execute the operating system so as to store, when writing of the data to the storage device is requested, the data stored in the first storage area in the second storage area, and thereafter write the data stored in the second storage area to the storage device.

In another general aspect, an information processing method is provided that causes an information processing device to update stored content of a storage device of a vehicle based on data received from a different controlling device. The information processing device includes a storage unit that includes a first storage area and a second storage area, a managing unit, and an updating unit. The information processing method includes: causing the managing unit to store, in the first storage area, data transmitted to the information processing device by the different controlling device; causing the managing unit to request the updating unit to write the data stored in the first storage area to the storage device when a prescribed update condition is met; causing, when the managing unit requests writing of the data to the storage device, the updating unit to store the data stored in the first storage area into the second storage area, and thereafter write the data stored in the second storage area to the storage device; and causing the managing unit to notify the different controlling device that writing of the data has been completed.

In a further general aspect, a non-transitory storage medium stores a management program configured to be executed by a processor included in an information processing device that manages a storage device of a vehicle. The information processing device includes a storage unit including a first storage area and a second storage area. The information processing device is configured to store, when requested to write data received form the different controlling device to the storage device, the data received from the different controlling device in the second storage area, and thereafter write the data stored in the second storage area to the storage device. The management program is configured to cause the processor to store, in the first storage area, data transmitted by the different controlling device, request writing of the data stored in the first storage area to the storage device when a prescribed update condition is met, and notify the different controlling device that writing of the data has been completed after requesting writing of the data to the storage device.

Other features and aspects will be apparent from the following detailed description, the drawings, and the claims.

### BRIEF DESCRIPTION OF THE DRAWINGS

FIG. 1 is a block diagram schematically showing a control system including an information processing device according to an embodiment.

FIG. 2 is a block diagram showing a functional configuration of the control system shown in FIG. 1.

FIG. 3 is a flowchart showing a series of processes executed by the information processing device shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

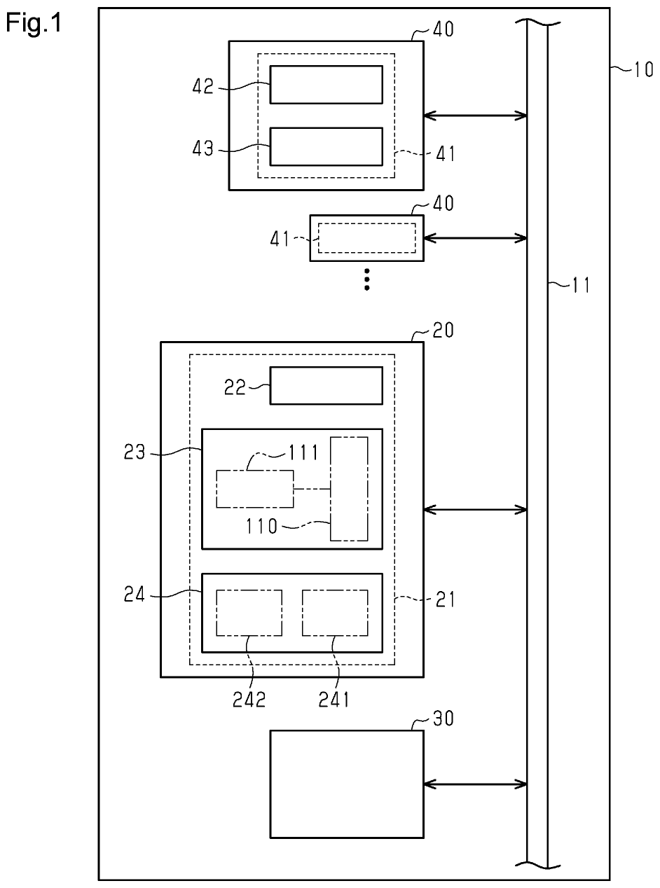

Hereinafter, an information processing device, an information processing method, and a management program according to one embodiment will be described with reference to FIGS. 1 to 3.

FIG. 1 illustrates a vehicle on-board control system 10. The control system 10 includes an information processing device 20, a storage device 30 managed by the information processing device 20, and multiple controlling devices 40. That is, the storage device 30 is mounted on a vehicle. The controlling devices 40 each correspond to a “different controlling device.” The information processing device 20, the storage device 30, and the controlling devices 40 transmit and receive data via a bus 11. The bus 11 is a controller area network (CAN), for example.

### Controlling Devices

The controlling devices 40 each include processing circuitry 41. For example, the processing circuitry 41 is an electronic control unit. In this case, the processing circuitry 41 includes a CPU 42 and a storage unit 43. The storage unit 43 stores a control program executed by the CPU 42. The CPU 42 may implement at least one function by executing the control program. The “function” mentioned here includes, for example, a function related to traveling of the vehicle, a function of storing an image of the interior or the outside of the vehicle, and a function of automatically updating firmware.

### Storage Device

The storage device 30 is capable of storing various types of programs and various types of data. The storage device 30 is a nonvolatile memory, which can be electrically rewritten. The storage device 30 is a NAND flash memory. One example of the storage device 30 is an embedded multimedia card (eMMC). The storage device 30 has an upper limit write count. The write count to the storage device 30 corresponds to the number of times data is written to the same memory cell. Therefore, “to write” here includes not only writing information to empty memory cells, but also overwriting the stored content of memory cells to which information has already been written. The upper limit write count of the storage device 30 is the number of times write operations can be performed in one memory cell or a specified memory frame. Therefore, the total capacity of the storage device 30, including data overwriting, is the product of multiplying the capacity of each memory cell or each memory frame, the number of memory cells or memory frames, and the number of writable times to each memory cell or each memory frame.

### Information Processing Device

The information processing device 20 includes processing circuitry 21. When the information processing device 20 receives data transmitted by the controlling device 40 via the bus 11, the processing circuitry 21 updates the stored content of the storage device 30 based on the received data. For example, the processing circuitry 21 is an electronic control unit. In this case, the processing circuitry 21 includes a CPU 22, a first storage unit 23, and a second storage unit 24. The CPU 22, which is a processor, corresponds to an “execution device.”

The first storage unit 23 stores a control program executed by the CPU 22. For example, the first storage unit 23 stores an operating system 110 and a management program 111. When the CPU 22 executes the operating system 110, the CPU 22 can write data received from the controlling device 40 to the storage device 30.

The management program 111 is an application program executed on the operating system 110. When the CPU 22 executes the management program 111, the CPU 22 can control the timing at which data is written to the storage device 30 and notify the controlling device 40 that data has been written to the storage device 30.

The second storage unit 24 temporarily stores calculation results of the CPU 22 and the like. For example, the second storage unit 24 includes a first storage area 241 and a second storage area 242. When the CPU 22 is executing the management program 111, the first storage area 241 temporarily stores data received via the bus 11. The first storage area 241 can store multiple pieces of data. The second storage area 242 stores data to be written to the storage device 30. That is, the CPU 22 temporarily stores data received from the controlling device 40 in the first storage area 241, and thereafter stores the data stored in the first storage area 241 in the second storage area 242. Thereafter, the CPU 22 writes the data stored in the second storage area 242 to the storage device 30.

### Functional Configuration

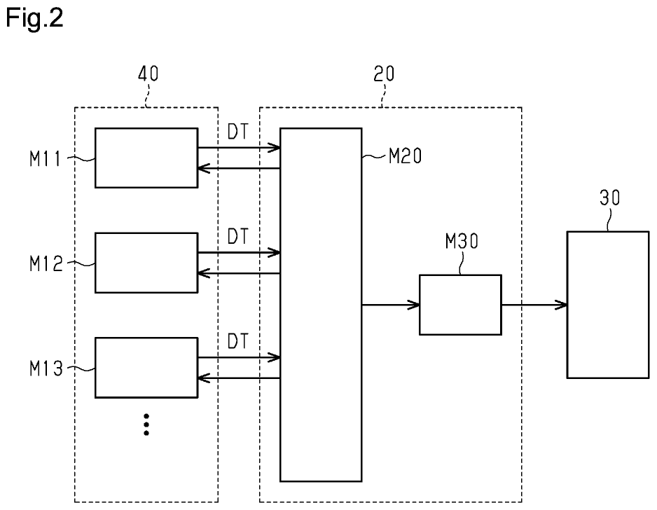

The functional configuration of the control system 10 will now be described with reference to FIG. 2.

As shown in FIG. 2, by executing control programs stored in the storage unit 43 of the controlling device 40, the CPU 42 functions as multiple functional units M11, M12, M13, and the like. Each of the multiple functional units M11, M12, M13, and the like corresponds to one of the above-described functions implemented by the CPU 42. By executing the operating system 110 stored in the first storage unit 23 of the information processing device 20, the CPU 22 functions as an updating unit M30. The updating unit M30 executes processes related to writing of data DT to the storage device 30. When the CPU 22 executes the management program 111 stored in the first storage unit 23, the CPU 22 functions as a managing unit M20. The managing unit M20 executes processes related to management of writing of data DT to the storage device 30.

The multiple functional units M11, M12, M13, and the like transmit data DT to be written to the storage device 30.

When receiving the data DT from the functional units M11, M12, M13, and the like, the managing unit M20 stores the data DT in the first storage area 241. That is, the first storage area 241 functions as a queue of the managing unit M20. Accordingly, the first storage area 241 stores multiple pieces of the data DT.

The managing unit M20 requests the updating unit M30 to write the data DT stored in the first storage area 241 to the storage device 30 when a prescribed update condition is met. For example, when at least one of the following two conditions (A1) and (A2) is met, the managing unit M20 determines that the update condition is met.

(A1) The number of pieces of the data stored in the first storage area 241 reaches a prescribed number.

(A2) A prescribed amount of time has elapsed since the managing unit M20 last received the data DT.

The prescribed number is set to a number corresponding to the storage capacity of the first storage area 241. For example, the prescribed number is set to a value greater than or equal to 2. The managing unit M20 thus prevents overflow from occurring in the in the first storage area 241.

If the next data DT is not transmitted from a functional unit even after a certain amount of time has elapsed since the managing unit M20 last received the data DT, the functional unit may have stopped functioning. Accordingly, the prescribed amount of time is set to a duration after which it can be determined that the functional unit has stopped. Therefore, when the condition (A2) is met, the managing unit M20 presumes that the functional unit has stopped, and thus determines that the update condition is met.

After requesting the updating unit M30 to write the data DT to the storage device 30, the managing unit M20 notifies the function units M11, M12, M13, and the like that writing of the data DT has been completed.

The functional units M11, M12, M13, and the like may determine that it is unnecessary to write the data DT to the storage device 30 after transmitting the data DT to the information processing device 20. In such a case, the functional units M11, M12, M13, and the like may transmit, to the information processing device 20, a request to cancel writing of the data DT to the storage device 30. Such a request is referred to as a “cancel request.” When receiving a cancel request from a functional unit, the managing unit M20 deletes the data DT stored in the first storage area 241. For example, the managing unit M20 deletes all the data DT stored in the first storage area 241.

When requested to write the data DT to the storage device 30 by the managing unit M20, the updating unit M30 stores all the data DT stored in the first storage area 241 into the second storage area 242. In other words, the second storage area 242 functions as a cache memory of the updating unit M30. Then, the updating unit M30 writes all the data DT stored in the second storage area 242 to the storage device 30.

### Information Processing Method

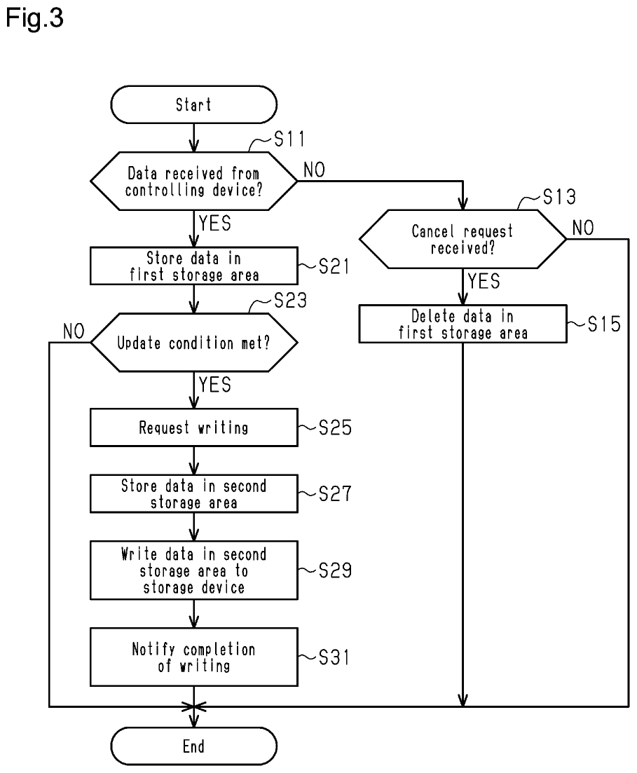

FIG. 3 illustrates an execution procedure of various processes in the information processing method. The CPU 22 of the information processing device 20 executes a series of processes shown in FIG. 3 at each prescribed control cycle.

In step S11, the CPU 22 determines whether the CPU 22 has received the data DT from the controlling device 40. When the data DT has been received (S11: YES), the CPU 22 advances the process to step S21. When the data DT has not been received (S11: NO), the CPU 22 advances the process to step S13.

In step S13, the CPU 22 determines whether the cancel request has been received from the controlling device 40. When the cancel request has been received (S13: YES), the CPU 22 advances the process to step S15. When the cancel request has not been received (S13: NO), the CPU 22 temporarily ends the series of processes.

In step S15, the CPU 22 functions as the managing unit M20 to delete the data DT in the first storage area 241. Specifically, the CPU 22 executes the management program 111 to delete the data DT in the first storage area 241. For example, when multiple pieces of data DT are stored in the first storage area 241, the CPU 22 deletes all the pieces of the data DT stored in the first storage area 241. Subsequently, the CPU 22 temporarily ends the series of processes.

In step S21, the CPU 22 functions as the managing unit M20 to store the data DT in the first storage area 241. Specifically, the CPU 22 stores the data DT in the first storage area 241 by executing the management program 111. The CPU 22 then advances the process to step S23.

In step S23, the CPU 22 functions as the managing unit M20 to determine whether the above-described update condition is met. Specifically, the CPU 22 determines whether the update condition is met by executing the management program 111. When determining that the update condition is met (S23: YES), the CPU 22 advances the process to step S25. When determining that the update condition is not met (S23: NO), the CPU 22 temporarily ends the series of processes.

In step S25, the CPU 22 functions as the managing unit M20 to request writing of the data DT stored in the first storage area 241 to the storage device 30. Specifically, the CPU 22 executes the management program 111 to request writing of the data DT stored in the first storage area 241 to the storage device 30. The CPU 22 then advances the process to step S27.

In step S27, the CPU 22 functions as the updating unit M30 to store the data DT stored in the first storage area 241 in the second storage area 242. Specifically, the CPU 22 executes the operating system 110 to store the data DT stored in the first storage area 241 in the second storage area 242. The CPU 22 then advances the process to step S29.

In step S29, the CPU 22 functions as the updating unit M30 to write the data DT stored in the second storage area 242 to the storage device 30. Specifically, the CPU 22 executes the operating system 110 to write the data DT stored in the second storage area 242 to the storage device 30. The CPU 22 then advances the process to step S31.

In step S31, the CPU 22 functions as the managing unit M20 to notify the controlling device 40 that the writing of the data DT has been completed. Specifically, the CPU 22 executes the management program 111 to notify the controlling device 40 that the writing of the data DT has been completed. Subsequently, the CPU 22 temporarily ends the series of processes.

### Operation of Present Embodiment

When obtaining data DT that needs to be stored in the storage device 30, the controlling device 40 transmits the data DT to the bus 11. The information processing device 20 receives the data DT via the bus 11.

The CPU 22 of the information processing device 20 executes the management program 111 on the operating system 110 to store the data DT received from the controlling device 40 in the first storage area 241 of the second storage unit 24. Each time new data DT is received, the CPU 22 stores the data DT in the first storage area 241 until the above-described update condition is met. When determining that the update condition is met, the CPU 22 requests writing of the data DT to the storage device 30.

When writing of the data DT to the storage device 30 is requested, the CPU 22 executes the operating system 110 to store all the data DT stored in the first storage area 241 in the second storage area 242. As a result, the data DT stored in the first storage area 241 is deleted from the first storage area 241.

Subsequently, the CPU 22 writes all the data DT stored in the second storage area 242 to the storage device 30. Then, the CPU 22 executes the management program 111 to notify the controlling device 40 via the bus 11 that the writing of the data DT to the storage device 30 has been completed.

### Advantages of Present Embodiment

(1) When writing the data DT to the storage device 30, the CPU 22 of the information processing device 20 executes the management program 111 to notify the controlling device 40 that the writing of the data DT to the storage has been completed. Thus, even without transmitting an instruction to write the data DT to the storage device 30 to the information processing device 20, the controlling device 40 ascertains that the data DT has been written to the storage device 30. Therefore, the information processing device 20 is capable of causing the controlling device 40 to ascertain that the data DT has been written to the storage device 30, while preventing the number of times that the controlling device 40 accesses the information processing device 20 from increasing.

(2) The CPU 22 determines that the update condition is met when the number of pieces of the data DT stored in the first storage area 241 reaches the prescribed number. This allows the information processing device 20 to write the data DT to the storage device 30 before overflow occurs in the first storage area 241 due to a continuous increase in the data DT accumulated in the first storage area 241.

(3) The CPU 22 determines that the update condition is met when the prescribed amount of time has elapsed since the latest reception of the data DT. Accordingly, in a case in which it can be determined that the functional unit of the controlling device 40 has stopped, the information processing device 20 is capable of writing the data DT accumulated in the first storage area 241 to the storage device 30.

(4) When receiving the cancel request from the controlling device 40, the CPU 22 deletes the data DT in the first storage area 241. Accordingly, when receiving a cancel request from the controlling device 40, the information processing device 20 prevents the data DT from being written to the storage device 30.

### Modifications

The above-described embodiment may be modified as follows. The above-described embodiment and the following modifications can be combined as long as the combined modifications remain technically consistent with each other.

After transmitting multiple pieces of the data DT to the information processing device 20, the controlling device 40 may transmit, to the information processing device 20, a request to cancel writing of a part of the pieces of the data DT to the storage device 30. In such a case, the CPU 22 of the information processing device 20 may delete only that part of the pieces of the data DT stored in the first storage area 241. As a result, the information processing device 20 is prevented from writing that part of the pieces of the data DT to the storage device 30.

The update condition does not necessarily include the condition (A1) as long as it includes the condition (A2). Conversely, the update condition does not necessarily include the condition (A2) as long as it includes the condition (A1).

In the above-described embodiment, the CPU 22 notifies the controlling device 40 that the writing of the data DT to the storage device 30 has been completed after writing the data DT to the storage device 30. However, the present disclosure is not limited thereto. For example, the CPU 22 may notify the controlling device 40 that the writing has been completed, triggered by the fact that data DT, which is stored in the first storage area 241, has been stored in the second storage area 242. In other words, in the series of processes shown in FIG. 3, the CPU 22 may execute the process of step S31 between step S27 and step S29.

In the above-described embodiment, the writing of the data DT to the storage device 30, which is provided separately from the information processing device 20, has been described. However, the present disclosure is not limited to this. For example, when the information processing device 20 includes a nonvolatile memory, the nonvolatile memory can be regarded as a storage device. Accordingly, the CPU 22 of the information processing device 20 may execute the series of processes shown in FIG. 3 when writing the data DT received from the controlling device 40 to its own nonvolatile memory.

The processing circuitry 21 is not limited to a device that includes a CPU and a ROM and executes software processing. In other words, the processing circuitry 21 may have any one of the following configurations (a), (b), and (c).

(a) The processing circuitry 21 includes one or more processors that execute various processes in accordance with a computer program. Each processor includes a CPU and a memory, such as a RAM and a ROM. The memory stores program codes or instructions configured to cause the CPU to execute processes. The memory, which is a computer-readable medium, includes any type of media that are accessible by general-purpose computers and dedicated computers.

(b) The processing circuitry 21 includes one or more exclusive hardware circuits that execute various processes. The dedicated hardware circuits include, for example, an application specific integrated circuit (ASIC) and a field programmable gate array (FPGA).

(c) The processing circuitry 21 includes a processor that executes part of various processes in accordance with a computer program and an exclusive hardware circuit that executes the remaining processes.

The expression “at least one” as used herein means “one or more” of desired options. As an example, the expression “at least one” as used herein means “only one option” or “both two options” if the number of options is two. As another example, the expression “at least one” used herein means “only one option” or “a combination of any two or more options” if the number of options is three or more.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An information processing device configured to update stored content of a storage device of a vehicle based on data received from a different controlling device, the information processing device comprising:
a processor;
a first storage unit; and
a second storage unit, wherein
the first storage unit is configured to store an operating system and a management program executed on the operating system,
the second storage unit includes a first storage area and a second storage area,
the processor is configured to execute the management program so as to
store the data received from the different controlling device in the first storage area, and
request, when a prescribed update condition is met, writing of the data stored in the first storage area to the storage device, and thereafter notify the different controlling device that writing of the data has been completed, and
the processor is configured to execute the operating system so as to store, when writing of the data to the storage device is requested, the data stored in the first storage area in the second storage area, and thereafter write the data stored in the second storage area to the storage device.

2. The information processing device according to claim 1, wherein the processor is configured to determine that the update condition is met when a number of pieces of the data stored in the first storage area reaches a prescribed number.

3. The information processing device according to claim 1, wherein the processor is configured to determine that the update condition is met when a prescribed amount of time has elapsed since the data was last received from the different controlling device.

4. The information processing device according to claim 1, wherein the processor is configured to execute the management program so as to delete the data stored in the first storage area when receiving, from the different controlling device, a request to cancel the writing of the data to the storage device.

5. The information processing device according to claim 1, wherein the processor is configured to execute, in a situation in which multiple pieces of the data are stored in the first storage area, the management program so as to delete part of the multiple pieces of the data stored in the first storage area when receiving, from the different controlling device, a request to cancel writing of the part of the multiple pieces of the data to the storage device.

6. The information processing device according to claim 1, wherein
the processor is configured to execute the management program so as to execute a process related to management of writing of the data to the storage device, and
the processor is configured to execute the operating system so as to execute a process related to writing of the data to the storage device.

7. An information processing method for causing an information processing device to update stored content of a storage device of a vehicle based on data received from a different controlling device, the information processing device including a storage unit that includes a first storage area and a second storage area, a managing unit, and an updating unit, the information processing method comprising:
causing the managing unit to store, in the first storage area, data transmitted to the information processing device by the different controlling device;
causing the managing unit to request the updating unit to write the data stored in the first storage area to the storage device when a prescribed update condition is met;
causing, when the managing unit requests writing of the data to the storage device, the updating unit to store the data stored in the first storage area into the second storage area, and thereafter write the data stored in the second storage area to the storage device; and
causing the managing unit to notify the different controlling device that writing of the data has been completed.

8. A non-transitory storage medium storing a management program configured to be executed by a processor included in an information processing device that manages a storage device of a vehicle, wherein
the information processing device includes a storage unit including a first storage area and a second storage area,
the information processing device is configured to store, when requested to write data received form the different controlling device to the storage device, the data received from the different controlling device in the second storage area, and thereafter write the data stored in the second storage area to the storage device, and
the management program is configured to cause the processor to:
store, in the first storage area, data transmitted by the different controlling device:
request writing of the data stored in the first storage area to the storage device when a prescribed update condition is met; and
notify the different controlling device that writing of the data has been completed after requesting writing of the data to the storage device.
